(19) United States
(12) Patent Application Publication
(10) Pub. No.: US 2010/0074140 A1
(43) Pub. Date: Mar. 25, 2010

(54) DATA PROCESSING METHOD AND SYSTEM

(75) Inventor: Charles Michael Markham, Sheffield (GB)

Correspondence Address: WILMERHALE/BOSTON, 60 STATE STREET, BOSTON, MA, 02109, US

(73) Assignee: JENNIC LTD, Sheffield (GB)

(21) Appl. No.: 12/235,001

(22) Filed: Sep. 22, 2008

(51) Int. Cl. H04L 12/28

(52) U.S. Cl. 370/254

(57) ABSTRACT

Certain embodiments of the invention relate to a method and system for managing routing in a wireless network, the method comprising receiving an indication that a route to a first node via a routing node is invalid; and deleting, from routing information, information indicating the route to the first node via the routing node. Other embodiments of the invention relate to a method and system for managing routing in a wireless network, the method comprising receiving a message from a descendant node via a routing node; determining whether routing information indicates a route to the descendant node via the routing node; if the routing information does not indicate the route, adding information to the routing information indicating the route to the descendant node via the routing node; and forwarding the message to a destination node.

### FIELD OF THE INVENTION

Embodiments of the invention relate to methods and systems for managing wireless network routing.

### BACKGROUND TO THE INVENTION

In certain types of wireless networks, nodes in a network may be connected to each other in various ways. For example, some nodes act as end devices, which can send messages to and receive messages from other nodes. Some nodes may act as routers, which receive messages from nodes and forward the messages to destination nodes. In some types of network, a node may act as a coordinator that has the ability to manage certain aspects of some, or all, of the network.

When a link between two nodes breaks down, or a node leaves the network, this may cause some nodes to be isolated from the network in that some nodes may not be able to communicate with other nodes or the coordinator. Typically, one of the isolated nodes determines that it is isolated and informs the other isolated nodes that they are also isolated. Then, the isolated nodes all attempt to re-join the network by sending messages. Additionally or alternatively, the coordinator or other node may send broadcast messages throughout the entire network to attempt to locate the isolated nodes. These messages, and any messages that may be sent in response, may use bandwidth available to the wireless network and may cause or contribute to congestion. In a congested network, messages may experience long delays in reaching their destinations or may even be lost entirely. Additionally or alternatively, during congestion or when the isolated nodes are rejoining the network, the isolated nodes may be unavailable to the network, and may also be unavailable to each other.

It is an object of embodiments of the invention to at least mitigate one or more of the problems of the prior art.

### SUMMARY OF THE INVENTION

According to a first aspect of embodiments of the invention, there is provided a method of managing routing in a wireless network, the method comprising receiving an indication that a route to a first node via a routing node is invalid; and deleting, from routing information, information indicating the route to the first node via the routing node.

Embodiments of the invention thus allow deletion of routes when it is determined that a route is invalid. The determination may be made in response to an invalid route being used. For example, a message may be propagated by one or more routing nodes until it reaches a node from which it cannot be propagated any further. The route along which the message was propagated is therefore invalid because, for example, it has failed or is unusable.

In certain embodiments, the method comprises deleting the information only if the indication is received from the routing node. Therefore, deleting of possibly valid routes is avoided.

In certain embodiments, the method comprises forwarding the indication to a parent node. Therefore, for example, any invalid routes stored by the parent and possibly other ascendant nodes can also be deleted.

In certain embodiments, the method comprises receiving a message from a parent node, forwarding the message to the first node via the routing node, and receiving the indication in response to the forwarding. Therefore, the indication that the route is invalid is received in response to the invalid route being used. In certain embodiments, the method comprises receiving the message from the routing node, and forwarding the message to the parent node. Therefore, the message that was sent using the invalid route is not lost, and is instead propagated back through the network structure for alternative routing.

According to a second aspect of embodiments of the invention, there is provided a method of managing routing in a wireless network, the method comprising receiving a message from a descendant node via a routing node; determining whether routing information indicates a route to the descendant node via the routing node; if the routing information does not indicate the route, adding information to the routing information indicating the route to the descendant node via the routing node; and forwarding the message to a destination node.

Therefore, for example, if a message is received from a source node via a routing node that is not identified as a route to the source node, routing information can be amended or added to include the route to the source node. Thus, routing information is added or amended to routing nodes on demand, i.e. when messages are exchanged within a network not for the sole purpose of updating routing information.

In certain embodiments, the message comprises one of a data message and an establish route message. Where the message is a data message, for example, embodiments of the invention update the routing information and thus the routing information in one or more routers may be updated “on-demand”, i.e. when a new route is used that includes one or more routers (which may include the coordinator) in the “old” route (i.e. the invalid or “stale” route). Where the message comprises an establish route message, for example, a node that is rejoining the network may send an establish route message through the network, for example to a coordinator node via any ascendant nodes. An ascendant node that is a router in the old route as well as the new route will receive the establish route message and determine that the routing information it stores refers to an old route. The node may then update its routing information to relate to the new route.

According to a third aspect of embodiments of the invention, there is provided a system comprising a plurality of nodes arranged in a wireless network, the plurality of nodes including at least a first router node, the first router node arranged to: receive an indication that a route to a destination node via a second routing node is invalid; delete, from a routing table, a first entry indicating the route to the destination node via the second routing node if the indication is received from the second routing node; receive a message from a source node via a third descendant routing node; determine whether the routing table includes a second entry indicating a route to the source node via the third routing node; if the routing information does not include the second entry, add the second entry to the routing table indicating the route to the source node via the third routing node; and forward the message to a parent node of the first routing node.

### BRIEF DESCRIPTION OF THE DRAWINGS

Embodiments of the invention will now be described by way of example only, with reference to the accompanying figures, in which:

FIG. 1 shows an example of a structure of a wireless network;

FIG. 2 shows an example of a networking stack for a node in a wireless network;

FIG. 3 shows the wireless network of FIG. 1 where a node has rejoined the network;

FIG. 4 shows another example of a structure of a wireless network;

FIG. 5 shows the wireless network of FIG. 4 where a node has rejoined the network; and

FIG. 6 shows an example of a packet.

### DETAILED DESCRIPTION OF EMBODIMENTS OF THE INVENTION

Embodiments of the invention may reduce the network bandwidth used when one or more nodes leave the wireless network. For example, embodiments of the invention use demand-driven route repair whereby certain routes identified in routing tables in certain nodes in the wireless network are removed or updated when an attempt is made to use the routes and the route used or existing route is “stale” or no longer available. This may allow a node with one or more descendant nodes to rejoin a network while keeping the structure of the descendant nodes intact.

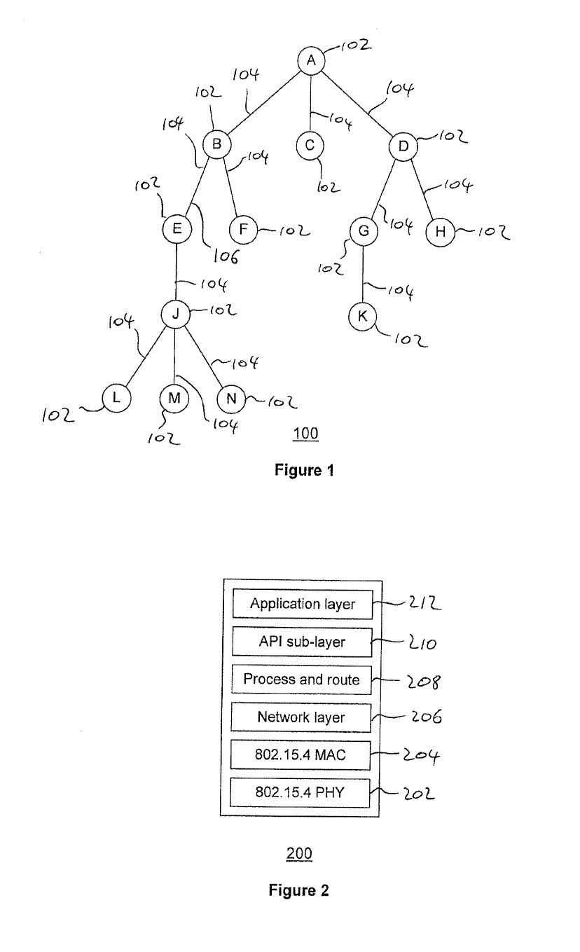

FIG. 1 shows an example of a wireless network 100. The wireless network 100 may be based on, for example, an IEEE 802.15.4-based wireless network such as, for example, a Zigbee™ network. Published standards and technical documents describing these and other wireless communication systems are incorporated herein by reference for all purposes. An example of a published standard is the 802.15.4-2006 standard, or the 802.15.4a-2007 standard, available from http://www.ieee802.org/15/pub/TG4.html. Examples of technical documents describing the ZigBee communication system are available from http://www.zigbee.org/en/spec download/zigbee_downloads.asp.

The wireless network 100 comprises a number of nodes 102 and a number of communication links 104. Each node 102 is connected to at least one other node 102. Two nodes 102 are connected to each other via a communication link 104.

The network 100 includes a coordinator node A. The network 100 has a hierarchical structure, and the coordinator node A is at the highest level of the hierarchy. All other nodes in the network are descendants of the coordinator node A, as they are lower down in the hierarchy. Descendants of the coordinator node A that are directly connected to the coordinator node A are called children of the coordinator node A. In the example wireless network 100 shown in FIG. 1, the coordinator node A has three children, which are the nodes B, C and D. The coordinator node A is the parent of the nodes B, C and D. Each node in the network, apart from the coordinator, has a single parent node. Nodes that are higher in the hierarchy than the parent node are called ascendant nodes. The coordinator node A has no parent or ascendant nodes.

The node B has two children, nodes E and F, and other descendant nodes, being nodes J, L, M and N. Thus, the node B is a router node, as communications that are sent to or from any of the nodes E, F, J, L, M and N may need to pass through the router node B. For example, a communication sent from the coordinator node A to the node F which is a child of B must pass through the router node B. The node B therefore performs routing by receiving the communication from A and forwarding it to F. Communications sent between descendant nodes of a routing node may not need to pass through the routing node. For example, communications sent between nodes E, J, L, M and N may not need to pass through node B.

The node F, which is a child of B, has no children or other descendant nodes. Therefore, the node F is not a routing node. Instead, the node F is an end device. An end device does not perform any routing functions, and may or may not have the capability to perform routing functions.

In the example wireless network 100 shown in FIG. 1, node A is a coordinator, nodes B, D, E, G and J are routing nodes, and nodes C, F, H, K, L, M and N are end devices. In other embodiments of the invention, the wireless network may include a different number of devices and/or may have any combination of routing and end device nodes.

Each routing node (including the coordinator node A) stores or has access to two tables. A first table, called a neighbour table, comprises a list of all of the children of the routing node. For example, for the wireless network 100 shown in FIG. 1, the routing node B includes the nodes E and F in its neighbour table, and the routing node G includes the node K in its neighbour table. A second table, called a routing table, provides a list of all of the descendant nodes of the routing node that are not children, and indicates the child node through which the descendant node can be accessed. For example, the routing table of the routing node B indicates that the nodes J, L, M and N are descendants but not children and can be accessed through the child node E. The routing table for the coordinator node A for the example wireless network 100 may comprise or indicate the following information:

| Descendant node | Access node |
|---|---|
| E | B |
| F | B |
| G | D |
| H | D |
| J | B |
| K | D |
| L | B |
| M | B |
| N | B |

When a source node sends a message to a destination node in the wireless network, the source node first checks the neighbour table to determine if the destination node is a child. If so, then the source node sends the message directly to the child node. If the destination node is not a child, the source node checks the routing table to determine whether the destination node is a descendant of the source node. If so, then the source node sends the message directly to the access node corresponding to the destination node as indicated in the routing table.

If the destination node is not in the neighbour table or the routing table, the source node sends the message to the source node's parent. The parent node, which is the coordinator or a routing node, can then route the message to the appropriate node. For example, the parent node may send the message directly to another routing node or the coordinator, or directly to the source node. An end device, which has no descendants, may not need to check the routing or neighbour table, and may send any messages that it generates directly to the parent node.

For example, within the wireless network 100 shown in FIG. 1, the node K may send a message to the node E, the destination node. The node K sends the message directly to the routing node G. The routing node G determines that the node E is not a descendant of the node G by checking its neighbour and routing tables. Thus, the node G sends the message directly to the routing node D. The node D determines that node E is not a descendant of node D and sends the message to the coordinator node A. The coordinator determines that node E is not a child, but is a descendant and can be reached via the node B. The coordinator node A thus sends the message to the routing node B. The node B determines that node E is a child and thus sends the message directly to the node E.

Consider, for example, that a communication link 106 between nodes B and E fails. For example, this may occur if node B loses power, if there is a hardware failure in node B or E, if interference increases to such an extent that the communication link 106 is no longer usable, or for some other reason. The nodes E, J, L, M and N are “isolated” nodes because they are no longer able to communicate with the rest of the network, for example with the coordinator node A.

The node E becomes aware that it is no longer connected to node B. The node E may become aware in a number of ways. For example, if the node E sends messages to or via node B, or polls node B for messages that should be sent to or from node E, the media access control (MAC) layer of the node E expects one or more acknowledgements from node B. The node E may, for example, conclude that the communication link 106 has failed if it fails to receive a predetermined number of acknowledgements. For example, the node E may conclude that the link 106 has failed if it has failed to receive the last five expected acknowledgements.

FIG. 2 shows an example of a networking stack 200 within a routing node, such as the routing node E. The stack 200 includes a physical (PHY) layer 202 that provides an interface to the transmission medium through which wireless messages may be sent. The MAC layer 204 interacts with the physical layer 202. A network layer 206 is responsible for network formation, discovery and joining functions and sending and receiving messages to/from parent and child nodes. A process and route layer 208 is responsible for receiving messages and forwarding them to the destination nodes via the appropriate parent or child node. Nodes that are end devices may omit this layer. An API sub-layer 210 provides a general interface to an application layer 212 for accessing the underlying layers.

Alternatively, for example, the node E may become aware that the communication link 106 has failed as follows. The node B may have removed the node E from its neighbour table, for example if it has concluded that the communication link 106 has failed. In this case, if the node E then attempts to send a message to or via node B and the message is received by node B, node B will determine that node E is not a child of node B and will send a message to node E that node B is not the parent of node E. For example, the node B sends an “unknown-node” message to node E. When the node E receives the message, it has been informed that the communication link 106 is no longer available.

Once node E is aware that it is no longer connected to node B, it will attempt to rejoin the wireless network. An example of a process for rejoining the network is described as follows. The node that has determined that a link to its parent is unavailable (for example, the node E in the above example) will perform a scan on each available communications channel by selecting a channel, requesting a beacon from any nodes using that channel, and waiting for a response. Each node using that communications channel that has received the request for a beacon will send a beacon to the node attempting to rejoin the network. If no beacons are received in response, or if no beacons are received from suitable nodes, the rejoining node will move on to another communications channel and repeat the process.

Where beacons are received, the rejoining node will select a node from the nodes from which beacons have been received. The selected node is selected according to one or more criteria. For example, the selected node may be selected according to the depth of the selected node within the network hierarchy, the number of children of the selected node, or the signal strength of communications sent between the rejoining node and the selected node. For example, the rejoining node may prefer to select a node that is higher in the network hierarchy, has fewer children and/or has a higher signal strength.

Once a node has been selected, the rejoining node attempts to rejoin the network so that the selected node is the parent of the rejoining node. The rejoining node sends an association request to the selected node. The selected node then determines whether the rejoining node is allowed to join the network with the selected node as parent. If so, the selected node sends a confirmation message to the selected node, and adds the rejoining node to its neighbour table. The rejoining node is then a child of the selected node.

The rejoining node then sends an “establish route” message up the network to the coordinator node, via the parent, if any, and any other ascendant nodes, if any. Each ascendant routing node, other than the parent of the rejoining node, determines whether the rejoining node is in its routing table. If not, then an entry is added to the routing node's routing table indicating that the rejoining node is a descendant node and can be reached through the routing node from which the establish route message was received. If there is an existing entry for the rejoining node, and the routing table information indicates that the route to the rejoining node is through a routing node that is different to the routing node from which the establish route message was received, then this information is out of date and indicates a “stale” route to the rejoining node, as the stale route is no longer available. Therefore, the routing node deletes this information from the routing table and adds a new entry to the routing table as indicated above. The routing node then passes the establish route message to its parent.

Eventually, the coordinator node will receive the establish route message. The coordinator then sends an establish route response message to the rejoining node. Once the rejoining node receives this message, the rejoining process is complete and the rejoining node has rejoined the network.

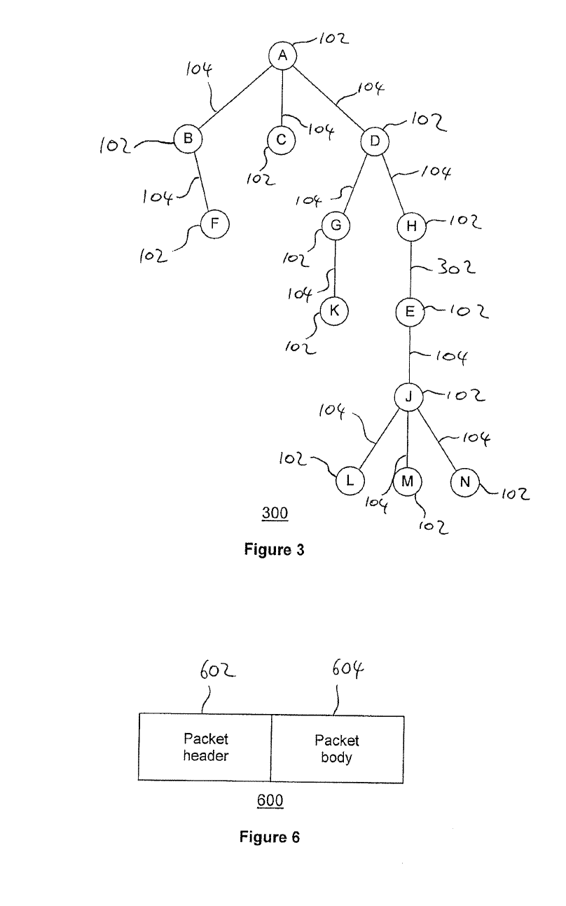

Consider that the communications link 106 between nodes B and E shown in FIG. 1 has failed or become unavailable, and the node E has rejoined the network with the node H as its parent. Even though the node H was an end device, in this example the node H has the ability to become a router node and thus the node E is able to select the node H as its parent. The resulting network structure 300 is shown in FIG. 3, with a new communications link 302 between the nodes E and H.

In the above described embodiment of the invention, the network structure that underlies the highest level isolated node, i.e. that includes all of the descendant nodes of the highest level isolated node, remains intact. For example, in the example networks 100 and 300 shown in FIGS. 1 and 3 respectively, the node J remains a child of the node E and the nodes L, M and N remain children of the node J and descendants of the node E. Therefore, when the communications link 106 between nodes B and E fails or becomes unavailable, descendant nodes of node E do not generate traffic to attempt to rejoin the network, and thus congestion of the network is reduced or avoided. Also, before the node E has rejoined the network, messages may still be sent between the nodes E, J, L, M and N. In certain embodiments of the invention, the nodes J, L, M and N may be unaware that they are isolated nodes.

As indicated above, a router node may determine that an establish route message has been received from a router node that is not the router node associated with the rejoining node in the routing table. The router node thus determines that the route indicated in the routing table is stale. In certain embodiments of the invention, the node may send a “delete route” message to the child node that is part of the route before removing the stale route information from the routing table. The child node may also forward the delete route message to the router node associated with the rejoining node in its own routing table, and delete this stale routing information from its routing table. Thus, any descendant nodes of a routing node that have stale routing information in their routing tables can be informed that the routing information is stale and can remove the stale routing information.

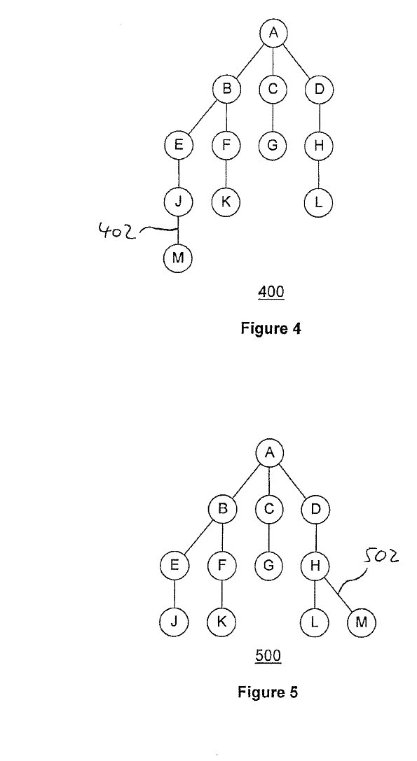

FIG. 4 shows another example of a structure of a wireless network 400. The wireless network 400 includes a coordinator node A and a number of descendant nodes B-M.

FIG. 5 shows another example of the structure of a wireless network 500. The wireless network 500 has the same structure as the wireless network 400, except that a communication link 402 between nodes J and M has failed or become unavailable, and the node M has rejoined the network with the node H as its parent, and there is a new communications link 502 between the nodes H and M. Using methods as described above, but without using delete route messages, in the network 500 the nodes A and D will include correct routing information to the node M within their routing tables. However, the nodes B and E will contain “stale” routing information that identifies the node M as a descendant of nodes B and E. Alternatively, for example, delete route messages may be used within the network 500 whereby one or more of the delete route messages may be “lost”, i.e. may have failed to reach their destination and/or any routing nodes. In this case, one or both of nodes B and E may contain stale routing information. It may be possible to lose a delete route message, for example, if a source or router node does not require an acknowledgement from another node that a message has been successfully transmitted. The lack of requirement for acknowledgements for these messages may reduce bandwidth required to transmit the messages but may result in one or more messages becoming “lost” as one or more transmissions are unsuccessful.

Messages may be sent from nodes A, C, D, H and L to the node M and vice versa without the stale routing information being used. For example, a message may be sent from node C to node M as the coordinator node A, the parent of node C, contains correct routing information for node M, as the establish route message from node M when it rejoined the network caused the coordinator node A to add information to its routing table to indicate that node M may be reached via node D.

However, if a message is sent from node K to node M, the stale routing information may be used as follows. The message is sent from node K to node F, which forwards the message to node B. However, the routing table of node B indicates that the node M can be reached via node E, which is no longer the case. Therefore, the node B includes stale routing information in its routing table. The node B forwards the message to node E. The node E also contains stale routing information in its routing table, as it forwards the message to node J.

Node J determines that node M is not a child node by checking its neighbour table, and also determines that there is not a route to node M via node J by checking its routing table. Therefore, the node J determines that the message has been sent along a stale route. Therefore, in embodiments of the invention, a delete route message is sent by node J to the coordinator node A, via any ascendant nodes as appropriate (in this example, the nodes B and E). The nodes B and E pass the delete route message to their respective parent and delete the stale routing information (that is, the routing information relating to the node M) from their respective routing table. The delete route message may identify the node M, allowing the nodes B and E to delete the appropriate routing information from their respective routing tables. Thus, the stale route to the node M through the nodes B, E and J has been removed from the wireless network 500. The node J may also send the message from node K back to the coordinator, from which it may be routed through the correct route. In alternative embodiments of the invention, for example, the message sent back to the coordinator may include or comprise an explicit or implied indication that the route is invalid, and the delete route message may not be used. For example, in an embodiment of the invention, a message may be routed along a stale route by a router node. A descendant node may send the message back up the network structure towards the coordinator. If the routing node receives the message (for routing up towards the coordinator) and notices that the message is the same as the one previously routed to a descendant node, it is implied that the message was sent along a stale route, and therefore the message comprises an implied indication that the route is invalid as the message has not been changed to explicitly state that the route is invalid.

Alternatively, for example, the node M may send a message to the node F while there is a stale route to node M through the nodes B, E and J. The message is passed from node M through nodes H and D to the coordinator node A. The coordinator node determines from its routing table that the destination node (node F) of the message can be reached via node B. The coordinator node A thus passes the message to node B. Node B determines from the neighbour table that the destination node is a child of node B, and thus passes the message to node F. However, the node B also determines that the message, which was generated by node M, has not been received by node B from node E, which would have happened if the routing information in the routing table of node B was correct. Thus, node B identifies the route to node M via node E as a stale route, and removes the information identifying this route from the routing table.

At this stage, there is still a stale routing table entry in the routing table of node E, which identifies that node M can be reached via node J. This can be resolved, for example, by the node B sending a delete route message to the node E, causing node E to delete the route to node M via node J from its routing table. The node E may also forward the delete route message to other descendant nodes.

Alternatively, for example, embodiments of the invention may implement background tasks within the wireless network that keep routing table information up to date. The time since each route entry in a routing table of a routing node was last used is monitored. If a route has not been used for a predetermined period of time, for example, then the node sends a “route purge” message to the destination node identified in that routing table entry. For example, the node B in the network 500 of FIG. 5 includes a route entry that indicates that the node K can be reached via node F. If no messages have been sent to node K through node B for a predetermined period of time, the node B sends a route purge message to the node K via node F. If the route is still valid then the route purge reaches the node K and no further action is taken. If the route is invalid, for example if the node K is no longer connected to the node F, then the route purge cannot reach its destination. For example, the node F may receive the route purge message with the node K as the destination and determine that there is no entry in the neighbour table or routing table corresponding to node K. The node F therefore sends a delete route message to the coordinator node A via the appropriate ascendant nodes (in this example, node B). The routing table entry corresponding to node K is therefore deleted from the appropriate ascendant nodes (in this example, nodes A and B). A node may delete a routing table entry if the child forwarding the delete route message matches that in the routing table entry corresponding to the source of the delete route message. If the routing table entry identifies that the source node can be reached through a node other than the child node that forwarded the message, the routing table entry could be a valid entry, and is not deleted.

At this point, there is no route from the coordinator to node K. Therefore, in embodiments of the invention, the coordinator node A sends a “find node” message through the network. The find node message is sent along all routes until the node K is found, in which case it may send an establish route message to create a valid route through all the ascendant nodes, including the coordinator. If the node K cannot be found then no route is created.

Additionally or alternatively, in certain embodiments of the invention, routing information may be kept up to date as follows. When a node rejoins a wireless network, it may have descendant nodes. Therefore, the new parent of the rejoining node may import routing table information from the rejoining node into its own routing table. For example, the new parent node may send “route request” messages to the rejoining node, each route request message causing the rejoining node to send a “route response” message back to the new parent containing one entry from the rejoining node's routing table. This may be performed for each entry in the rejoining node's routing table, and may be performed over an extended period of time so as to not use significant network bandwidth.

Thus, the above identified embodiments of the invention implement demand-driven route repair and other features that minimise the use of network bandwidth, reduce the number of messages generated and/or have other benefits compared to known networks when one or more nodes become isolated from the network and rejoin the network in a different place, i.e. with the highest level isolated node rejoining the network with a different parent.

The above description describes embodiments of the invention in terms of messages exchanged between nodes in a wireless network. Each message may comprise, for example, one or more packets. FIG. 6 shows an example of the structure of a packet 600. The packet 600 includes a packet header 602 and a packet body 604. The packet header 602 may contain, for example, an address identifying the source of the packet 600. The packet body 604 depends on the type of packet. The packet body 604 may be empty or not present, for example if the packet 600 is a delete route packet or unknown node packet. Alternatively, for example, the packet body 604 may include an address that identifies the destination node of the packet 600. For example, data packets, repair route packets, purge route packets, route import packets and route request packets may include a destination address. The packet body 604 may additionally or alternatively include other information. For example, data packets may include data or information that is sent between two nodes, for example for purposes other than network and/or routing maintenance. Thus, for example, a data message may comprise one or more data packets. An establish route message may not include a destination address, as an establish route packet is always sent by a node to its parent and eventually to the coordinator.

In alternative embodiments of the invention, the wireless network may be of a type other than an IEEE 802.15.4-based or Zigbee™ wireless network, and may be another type of wireless network, such as, for example, 802.11. Additionally or alternatively, for example, the structure of the wireless network may be different to the tree structure described above, and may be, for example, a mesh or star structure.

Embodiments of the invention may be beneficial where a significant number of nodes in a wireless network become unavailable or non-operational due to, for example, a power outage in part or all of the wireless network.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as claimed in any preceding claim and a machine readable storage storing such a program. Still further, embodiments of the present invention may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims.

1. A method of managing routing in a wireless network, the method comprising:
receiving an indication that a route to a first node via a routing node is invalid; and
deleting, from routing information, information indicating the route to the first node via the routing node.

2. A method as claimed in claim 1, comprising deleting the information only if the indication is received from the routing node.

3. A method as claimed in claim 1, comprising forwarding the indication to a parent node.

4. A method as claimed in claim 1, comprising:
receiving a message from a parent node;
forwarding the message to the first node via the routing node; and
receiving the indication in response to the forwarding.

5. A method as claimed in claim 4, comprising:
receiving the message from the routing node; and
forwarding the message to the parent node.

6. A method as claimed in claim 1, wherein the indication comprises a delete route message.

7. A method as claimed in claim 1, wherein the indication is received from the routing node.

8. A method of managing routing in a wireless network, the method comprising:
receiving a message from a descendant node via a routing node;
determining whether routing information indicates a route to the descendant node via the routing node;
if the routing information does not indicate the route, adding information to the routing information indicating the route to the descendant node via the routing node; and
forwarding the message to a destination node.

9. A method as claimed in claim 8, wherein forwarding the message to the destination node comprises sending the message to a parent node.

10. A method as claimed in claim 8, wherein the message comprises one of a data message and an establish route message.

11. A system arranged to implement at least one of the method as claimed in claim 1 and the method as claimed in claim 8.

12. A wireless network comprising a plurality of nodes, the plurality of nodes including at least one router node arranged to carry out at least one of the method as claimed in claim 1 and the method as claimed in claim 8.

13. A system comprising a plurality of nodes arranged in a wireless network, the plurality of nodes including at least a first router node, the first router node arranged to:
receive an indication that a route to a destination node via a second routing node is invalid;
delete, from a routing table, a first entry indicating the route to the destination node via the second routing node if the indication is received from the second routing node;
receive a message from a source node via a third descendant routing node;
determine whether the routing table includes a second entry indicating a route to the source node via the third routing node;
if the routing information does not include the second entry, add the second entry to the routing table indicating the route to the source node via the third routing node; and
forward the message to a parent node of the first routing node.

14. A system as claimed in claim 13, wherein the message comprises one of a data message and an establish route message.

15. A computer program comprising computer readable instructions for implementing at least one of the method as claimed in claim 1 and the method as claimed in claim 8.

16. Computer readable storage storing a computer program as claimed in claim 15.
